(19) United States
(12) Patent Application Publication
(10) Pub. No.: US 2011/0113681 A1
(43) Pub. Date: May 19, 2011

(54) USE OF BY-PRODUCT CARBON DIOXIDE FROM A STEAM METHANE REFORMER IN AN ALGAE BIOFUEL PRODUCTION PROCESS

(76) Inventors: Mathias Mostertz, Munich (DE); John J. Brull, Basking Ridge, NJ (US)

(21) Appl. No.: 12/618,992

(22) Filed: Nov. 16, 2009

(51) Int. Cl. A01G 7/00

(52) U.S. Cl. 47/1.4

(57) ABSTRACT

Carbon dioxide that is collected as a by-product of hydrogen production from a steam methane reformer (SMR) is used as a feed stock for growth of algae biomass for various purposes, e.g. biofuel production, chemical intermediates, nutraceuticals or pharmaceuticals. This invention helps reduce emissions of carbon dioxide, a known greenhouse gas, and helps to optimize algae growth that is used for the production clean biofuel to reduce the dependence on petroleum and fossil fuels.

### FIELD OF THE INVENTION

The present invention relates to methods and apparatus that use by-product carbon dioxide (CO₂) from a steam methane reformer (SMR) to provide feed for the growth of algae used in biomass production, including the production of algal biomass for any purpose, e.g. biofuel production, chemical intermediates, nutraceuticals or pharmaceuticals.

### BACKGROUND OF THE INVENTION

Methane reformers are devices used to produce pure hydrogen from natural gas, such as methane, and a catalyst, usually nickel. Two types of reformers are predominantly used in the industry, autothermal reforming and steam methane reforming (SMR), both working by exposing the natural gas to the catalyst at high temperature and pressure.

SMR employs an external source of gas to heated tubes in which a catalytic reaction takes place to convert steam and light hydrocarbons, e.g. natural gas or methane, into hydrogen and carbon monoxide, known as syngas. The syngas reacts further with the steam to produce higher yields of syngas along with carbon dioxide as a by-product. The syngas is then treated to remove the carbon oxide impurities, such as by a pressure swing adsorption process, to provide the pure hydrogen product.

While SMR is good at producing pure hydrogen, it unfortunately also produces significant amounts of carbon dioxide which is normally vented to the atmosphere. Carbon dioxide is a known greenhouse gas that contributes to the problem of global warming and current legislation in the United States and other countries around the world are aimed at reducing carbon dioxide emissions from all manner of industrial processes.

In addition, there is interest in funding projects related to the production of green alternate energy sources, such as hydrogen fuel for transportation and algae biomass production for conversion to biofuels. Because algae is very fast growing, up to ten times faster than land based plants or food crops, and has a harvesting cycle ranging from one to ten days, several harvests can be obtained in a very short time frame, resulting in a significantly higher yield of algal biomass and thus a higher yield of biofuel compared to that obtained from land based plants or food crops. Algae production is of particular interest in reducing the world consumption of petroleum, because some algae species can produce significantly greater amounts of biofuel per acre than other vegetable sources, e.g. corn, soybeans, palm, rape seed, etc. In addition, creating biofuel from algae has the benefit of not using vegetables that could be better used for fighting world hunger. Moreover, algae production can often be carried out on land or space not suitable for vegetable crop growth, such as arid land, land with excessively saline soil, and drought-stricken land. Biodiesel produced from algae is an environmentally friendly, green, renewable fuel that has little or no noxious gas release during the process of combustion, and requires about one eighth of the energy required to produce ethanol.

The production of biomass from algae is a relatively simple process. Algae growth requires a beginning algae mass, water, carbon dioxide and solar irradiation. The algae convert carbon dioxide and sunlight into oxygen and biomass, mainly carbohydrates, lipids/starch and proteins, by photosynthesis. It has been shown that up to 95 percent of the carbon dioxide introduced in the culture broth can be converted. Biofuel is than produced from harvested and dewatered algae through a process known as transesterification, the process of exchanging an organic group of an ester with the organic group of an alcohol.

There are two primary systems used for algae growth, open-pond systems and closed systems wherein nutrient laden water is exposed to sunlight using plastic tubes, referred to as photobioreactors (PBR). Open pond systems require hardier strains of algae to withstand temperature and pH changes as well as competition from invasive algae and bacteria. PBRs generally enable higher yields because the algae does not have to divert energy away from growth to deal with other issues, but are more expensive to operate that open pond systems. For either system, open pond or PBR, a cheap source of carbon dioxide is necessary. It is important for PBRs that the carbon dioxide be sterile, to avoid contamination.

There remains a need for improvements to the process of growing algae for biomass and subsequent biofuel production.

### SUMMARY OF THE INVENTION

The present invention provides methods and apparatus utilizing by-product carbon dioxide from a steam methane reformer as a feed stock for the growth of algae to be used in the production of biomass for various purposes, including biofuel production. The present invention helps to reduce the emissions of carbon dioxide, a known greenhouse gas, from an industrial SMR process, by using the carbon dioxide as a source for algae growth. In addition, the present invention provides a method for producing green energy biofuel to help reduce dependence of fossil fuels and aid in the reduction of greenhouse gas emissions.

### BRIEF DESCRIPTION OF THE DRAWINGS

FIG. 1 is a schematic drawing of an apparatus in accordance with one embodiment of the present invention.

### DETAILED DESCRIPTION OF THE INVENTION

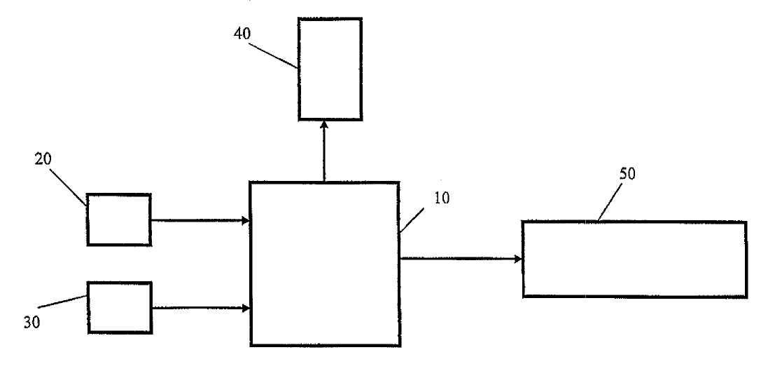

The present invention is relates to methods and apparatus that use by-product carbon dioxide from a steam methane reformer (SMR) to provide feed for the growth of algae biomass, which could be used in green energy biofuel production. The invention will be described in more detail with reference to FIG. 1.

FIG. 1 is a schematic drawing of an apparatus according to one embodiment of the present invention. In particular, FIG. 1, shows an SMR process chamber (10) having natural gas feed (20) and stream feed (30). The process chamber (10) uses the natural gas and steam to form syngas that can be collected in a collection vessel, such as tank (40) for further processing and purification to produce pure hydrogen, and carbon dioxide as a by-product. In accordance with the present invention, the carbon dioxide from the SMR process is transported to an algae growing process (50) for use as a feed to be converted to oxygen and algae biomass through photosynthesis. The algae can then be harvested and processed to product biofuel.

The carbon dioxide can be used in all kinds of algae culturing systems, i.e. in closed PBRs as well as in open-pond systems. Before introduction of the carbon dioxide into the algae culture broth, the carbon dioxide must be free of impurities such as SOx, and needs to be at ambient temperature and sufficient pressure to enter the aqueous phase. Therefore, the carbon dioxide from the SMR is first treated to remove the impurities and heated or cooled to the ambient temperature, as well as pressurized to the appropriate pressure.

The carbon dioxide collected from the SMR process may be transported to the algae growing facility in any manner, including by cylinder truck, tanker truck, train, pipeline, etc. Advantageously, to save on transportation costs and to reduce the cost of biomass production, the SMR and algae growing facility can be located near enough to one another to make delivery by pipeline directly from the SMR to the algae growth area feasible.

The present invention provides several advantages. In particular, carbon dioxide from an SMR operation can be put to productive use instead of vented to the atmosphere, thus reducing greenhouse emissions and helping in the efforts to reduce the threat of global warming. Further, by providing a cheap and steady source of carbon dioxide for an algae production operation, consistent growth cycles for the algae can be achieved and algae production can be optimized. The algae grown can then be converted into clean biofuel to help reduce the dependence on fossil fuels, or may be used as intermediates or building blocks for green chemistry. In comparison to flue gas from fossil fuel operated power plants that contains from 4% to 15% carbon dioxide, the by-product carbon dioxide from an SMR plant is almost pure. Therefore, the transport and processing necessary for algae plant production use is considerably less for SMR derived carbon dioxide, which results in less energy and processing costs and ultimately cheaper biomass production costs.

It will be understood that the embodiments described herein are merely exemplary and that one skilled in the art may make variations and modifications without departing from the spirit and scope of the present invention. All such variations and modifications are intended to be included within the scope of the invention as described above. Further, all embodiments disclosed are not necessarily in the alternative, as various embodiments of the invention may be combined to provide the desired result.

What is claimed is:

1. A system for the production of algal biomass comprising:
a steam methane reformer that produces by-product carbon dioxide;
means to collect the by-product carbon dioxide from the steam methane reformer;
means to transport the collected carbon dioxide from to an algae production facility; and
means to introduce the transported carbon dioxide to algal biomass production at the algae production facility.

2. A system according to claim 1 wherein the means to collect is a vessel or tank.

3. A system according to claim 1 wherein the means to transport by-product carbon dioxide comprises a tanker truck or train.

4. A system according to claim 1 wherein the means to transport by-product carbon dioxide comprises a pipeline.

5. A system according to claim 1 wherein the algal production facility is an open pond system or a closed photobioreactor system.

6. A system according to claim 1 further comprising means to purify and condition the collected carbon dioxide.

7. A system according to claim 6 wherein the means to purify and condition comprises a impurity removal means and a temperature and pressure adjustment means.

8. A system according to claim 1 further comprising means to harvest biomass produced at the algal production facility and means to process the harvested biomass for industrial use.

9. A system according to claim 8 wherein the industrial use is biofuel.

10. A system according to claim 8 wherein the industrial use is a chemical intermediate, a nutraceutical or a pharmaceutical.

11. A method for producing algal biomass comprising:
collecting by-product carbon dioxide from a steam methane reformer; and
using the collected by-product carbon dioxide in a algal biomass production process at an algae production facility.

12. A method according to claim 11 wherein the algal production facility is an open pond system or a closed photobioreactor system.

13. A method according to claim 11 further comprising purifying and conditioning the collected carbon dioxide.

14. A method according to claim 13 wherein purifying and conditioning comprises removing impurities from the collected carbon dioxide and adjusting the temperature and pressure of the carbon dioxide.

15. A method according to claim 11 further comprising harvesting biomass produced at the algal production facility processing the harvested biomass for industrial use.

16. A method according to claim 15 wherein the industrial use is biofuel.

17. A method according to claim 15 wherein the industrial use is a chemical intermediate, a nutraceutical or a pharmaceutical.
